(19) United States
(12) Patent Application Publication
(10) Pub. No.: US 2007/0118552 A1
(43) Pub. Date: May 24, 2007

(54) FILE EDITING SYSTEM AND METHOD THEREOF

(75) Inventors: Han-Che Wang, Shenzhen, Guangdong (CN); Chun-Wei Pan, Shenzhen, Guangdong (CN); Kuan-Hong Hsieh, Shenzhen, Guangdong (CN); Hua-Dong Cheng, Shenzhen, Guangdong (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/560,823

(22) Filed: Nov. 16, 2006

(30) Foreign Application Priority Data
Nov. 18, 2005 (CN) 200510101532.5

(51) Int. Cl. G06F 7/00; G09G 5/00

(52) U.S. Cl. 707/102; 345/1.1; 707/101

(57) ABSTRACT

A file editing system is provided. The file editing system includes: a first storage (41) for storing file contents; a primary display screen (31) for displaying the file contents thereon; a control device (20) for receiving commands and user comments taken regarding the file contents from a user; and a microcontroller unit (MCU, 10) for controlling the storing and displaying of the file contents and the user comments in accordance with the commands. The file editing system further includes a second storage (42) for storing the user comments under control of the MCU; and a secondary display screen (32) for displaying the user comments thereon under control of the MCU. A related file editing method is also provided.

### BACKGROUND

1. Technical Field

The present invention relates to file editing systems and methods thereof, and particularly to a power saving file editing system and method thereof.

2. Related Art

Generally, when reading texts, most people are accustomed to annotate texts, that is, the people usually jot comments on paper. Not so long ago, digital reading apparatuses are introduced and used by people to read texts. The digital reading apparatuses can store and display contents of a plurality of paper books. The digital reading apparatuses conform to small figures, and are popular among many people. However, while reading a text via a digital reading apparatus, if a person jots comments regarding the text and stores the comments together with the text as a resulting text, the comments will most likely become a disturbance for other people who read the resulting text at a later time.

Furthermore, while inputting comments via a digital reading apparatus, each time a character is inputted, a display of the digital reading apparatus is refreshed and displays the character inputted. Hence, if characters are inputted continuously, the display is refreshed continuously and therefore consumes a lot of electrical power.

Therefore, there is a need for providing a file editing system that can solve the above-mentioned problem.

### SUMMARY

A file editing system is provided in accordance with a preferred embodiment. The file editing system includes: a first storage for storing file contents; a primary display screen for displaying the file contents thereon; a control device for receiving commands and user comments taken regarding the file contents from a user; and a microcontroller unit (MCU) for controlling the first storage’ storing and primary display screen's displaying of the file contents in accordance with the commands. The file editing system further includes a second storage for storing the user comments under control of the MCU in accordance with the commands; and a secondary display screen for displaying the user comments thereon under control of the MCU in accordance with the commands.

A file editing method executed by the file display system described above is also provided. The method includes the steps of: (a) reading file contents from a first storage and displaying the file contents on a primary display screen; (b) receiving an edit command and activating a secondary display screen, the activation of the secondary display screen indicating a comment inputting mode of the file editing system is enabled and an editing of an user comment corresponding to the file contents is allowed; and (c) editing the user comment, displaying the user comment on the secondary display screen and storing the user comment in a second storage.

Other advantages and novel features will be drawn from the following detailed description with reference to the attached drawings, in which:

### BRIEF DESCRIPTION OF THE DRAWINGS

FIG. 1 depicts an exemplary schematic block diagram of a file editing system in accordance with a first preferred embodiment of the present invention;

FIG. 2 depicts a flowchart of a file editing method in accordance with a second preferred embodiment of the present invention; and

FIG. 3 depicts a flowchart of a file editing method in accordance with a third preferred embodiment of the present invention.

### DETAILED DESCRIPTION OF THE EMBODIMENTS

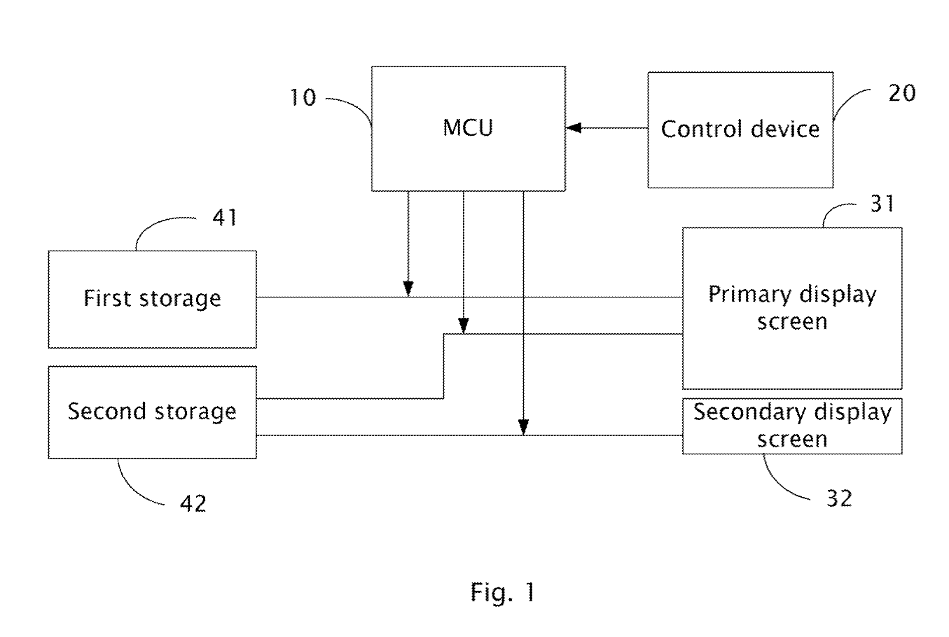

Referring to FIG. 1, an exemplary schematic block diagram of a file editing system (hereinafter “the system”) is shown. Here and hereinafter, only parts of the system that are necessary to illustrate the preferred embodiments of the present invention are shown and described. The parts include a microcontroller (MCU) 10, a control device 20, a primary display screen 31, a secondary display screen 32, a first storage 41, and a second storage 42. The first and second storages 41 and 42 may be incorporated in one non-volatile storage device, or may be separately incorporated in two different non-volatile storage devices. The first and second storages are respectively used for storing file contents and user comments corresponding to the file contents. The control device 20 receives commands and comments from the user via an input device(s) such as a keyboard (not shown), converts the commands and the comments into machine instructions readable/executable/processable by the MCU 10 and transmits the machine instructions to the MCU 10. The commands include, but not being limited to, open file commands, edit commands including edit file commands and edit comment commands, save comment commands, and open insertion mark commands.

The MCU 10 receives the commands, and manages the file contents and the comments according to the commands. The MCU 10 controls the comments to be displayed on the primary display screen 31 together with the file contents, or alternatively, controls the file contents and the comments to be displayed on the primary display screen 31 and the secondary display screen 32 respectively. The MCU 10 also enables the user to edit the comments via the secondary display screen 32. The comments edited are then stored in the second storage 42.

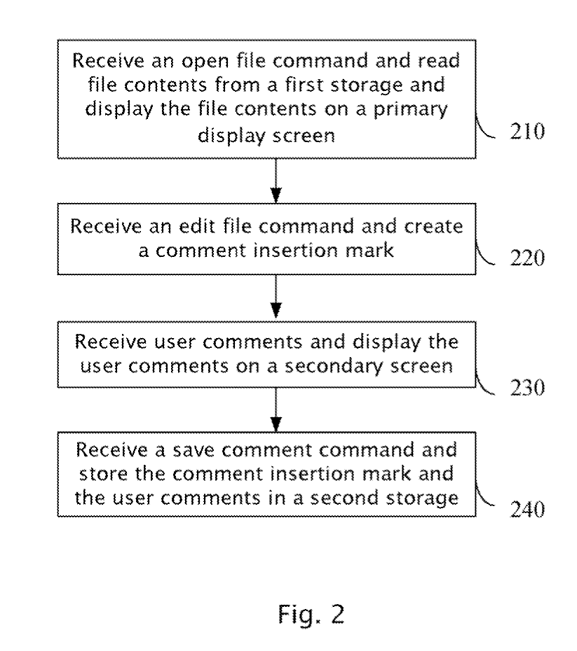

Referring to FIG. 2, a flowchart of a file editing method by utilizing the file editing system mentioned previously in accordance with a second embodiment of the present invention is shown. Firstly, after the file editing system is powered on and operating, the control device 20 receives the open file command from the user, and the open file command instructs the MCU 10 to read file contents of a user selected file from the first storage 41 and to display the file contents of the user selected file on the primary display screen 31 (step S210).

The control device 20 receives the edit file command, the edit file command instructs the MCU 10 to create the comment insertion mark that points to a selected area of the file contents displayed on the display screen 31 (step S220). After the comment insertion mark is created, the secondary screen 32 is activated indicating that a comment inputting mode of the system is enabled. In the comment inputting mode, the MCU 10 receives the user comments via the control device 20 and displays the user comments on the secondary screen 32 (step S230). The control device 20 receives the save comment command, and the save comment command instructs the MCU 10 to store the comment insertion mark and the user comments together in the second storage 42 (step S240).

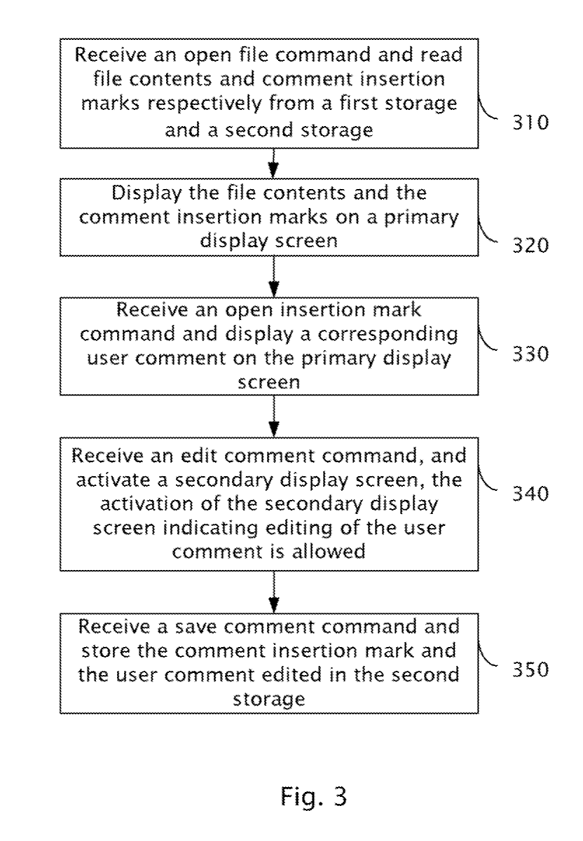

Referring to FIG. 3, a flowchart of a file editing method by utilizing the file editing system mentioned in the foregoing in accordance with a third embodiment is shown. Firstly, after the file editing system is powered on and operating, the control device 20 receives the open file command from the user, and the open file command instructs the MCU 10 to read the file contents of the user selected file from the first storage 41, the MCU 10 then further reads comment insertion marks that point to selected areas of the file contents from the second storage 42 (step S310). The MCU 10 displays the file contents and the comment insertion marks together on the primary display screen 31 (step S320).

The control device 20 receives the open insertion mark command, in this preferred embodiment, the open insertion mark command is generated when one of the comment insertion marks is activated/selected by an input device such as a keyboard (not shown), the MCU 10 receives the open insertion mark command and displays the user comment corresponding to the comment insertion mark on the primary display screen (step S330).

The control device 20 receives the edit comment command, and the edit comment command instructs the MCU 10 to display the user comment on the secondary display screen 32, the MCU 10 then activates the secondary display screen 32 indicating that the comment inputting mode of the system is enabled and editing the user comment is thus allowed, the user edits the user comment and the edited user comment is displayed on the display screen 32 (step S340). The control device 20 receives the save comment command, and the save comments command instructs the MCU 10 to store the comment insertion mark and the user comments edited together in the second storage 42 (step S350).

Upon receiving the open insertion mark command in the third preferred embodiment described above, instead of displaying the user comment on the primary display screen in step S330, the MCU 10 may directly display the user comment on the secondary display screen 32. The MCU 10 activates the secondary display screen and the system accordingly enters into the comment inputting mode. The user edits the user comment and the edited user comment is displayed on the secondary display screen 32 after receiving the edit comment command in step S340.

To reduce power consumption, two things can be further considered regarding the system, one is to configure the secondary display screen to be of a smaller size with poorer specifications as compared with the primary display screen 31, and the another is to configure the primary display screen to be bistable so that no power is used to show the file content between page flippings and comment insertion marking creations.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A file editing system, comprising:
a first storage for storing file contents;
a primary display screen for displaying the file contents thereon;
a control device for receiving commands and user comments taken regarding the file contents from a user;
a microcontroller unit (MCU) for controlling the first storage's storing and the primary display screen's displaying of the file contents in accordance with the commands;
a second storage for storing the user comments under control of the MCU in accordance with the commands; and
a secondary display screen for displaying the user comments under control of the MCU in accordance with the commands.

2. The file editing system as claimed in claim 1, wherein the MCU creates a comment insertion mark that points to a selected area of the file contents displayed on the primary display screen.

3. The file editing system as claimed in claim 2, wherein the comment insertion mark is stored in the second storage and displayed on the primary display screen under control of the MCU.

4. The file editing system as claimed in claim 3, wherein the comment insertion mark is selected and the user comment corresponding to the selected comment insertion mark is displayed on the primary display screen or on the secondary display screen.

5. The file editing system as claimed in claim 4, wherein the commands comprises edit comment commands, the secondary display screen is activated upon receiving an edit comment command, and the activation of the secondary display screen indicates that a comment inputting mode of the file editing system is enabled and an editing of the user comment is allowed.

6. A file editing method, comprising the steps of:
reading file contents from a first storage and displaying the file contents on a primary display screen;
receiving an edit command and activating a secondary display screen, the activation of the secondary display screen indicating a comment inputting mode is enabled and an editing of a user comment corresponding to the file contents is allowed; and
editing a comment, displaying the user comment on the secondary display and storing the user comment in a second storage.

7. The file editing method as claimed in claim 6, the receiving and activating step further comprises: creating a comment insertion mark that points to a selected area of the file contents displayed on the primary display screen.

8. The file editing method as claimed in claim 6, wherein the reading and displaying step further comprises: reading comment insertion marks which point to selected areas of the file contents displayed on the primary display screen and displaying the comment insertion marks on the primary display screen.

9. The file editing method as claimed in claim 8, further comprising the step of: selecting one of the comment insertion marks and displaying the user comment corresponding to the comment insertion mark on the primary display screen or on the secondary display screen.
